(19) United States
(12) Patent Application Publication
(10) Pub. No.: US 2002/0198811 A1
(43) Pub. Date: Dec. 26, 2002

(54) System and method for monitoring the status of analyses performed on a portfolio of financial instruments

(76) Inventors: Adam Wizon, New providence, NJ (US); Joseph M. Kochansky, New York, NY (US)

Correspondence Address: CUMMINGS & LOCKWOOD, Granite Square, 700 State Street, P.O. Box 1960, New Haven, CT, 06509-1960, US

(21) Appl. No.: 10/157,595

(22) Filed: May 29, 2002

Related U.S. Application Data
(60) Provisional application No. 60/297,519, filed on Jun. 12, 2001.

(51) Int. Cl. G06F 17/60

(52) U.S. Cl. 705/36

(57) ABSTRACT

A system and method for monitoring the status of analyses performed on a portfolio of financial instruments which applies selected analytical formulas to model the performance of selected financial instruments within a selected portfolio and automatically communicates the durational status of the application of the selected analytical formulas with respect to each selected financial instrument until the application is finalized.

### CROSS-REFERENCE TO RELATED APPLICATION

The subject application claims the benefit of commonly owned, co-pending U.S. Provisional Application Serial No. 60/297,519, filed Jun. 12, 2001, the disclosure of which is herein incorporated by reference in its entirety.

### BACKGROUND OF THE INVENTION

1. Field of the Invention

The subject disclosure is directed to a system and method for performing analyses on a portfolio of financial instruments such as fixed income securities, and more particularly, to an automated system for monitoring the status of the analyses as applied to each financial instrument in a portfolio of financial instruments.

2. Background of the Related Art

Risk management, as it applies to fixed income securities and portfolio management as a whole, involves several distinct steps. The first step involves identifying the relevant systemic risk factors or variables that cause fluctuations of market prices of securities and portfolios. Some risk factors are directly observable and measurable such as Gross Domestic Product (GDP), mortgage origination rates, and yields on U.S. Treasury bonds and other liquid securities. Other risk factors cannot be readily observed, such as spot rates, option-adjusted spreads, and other composite variables.

The second step involves measuring the exposure of securities to each risk factor and aggregating these exposures across each of the securities in a portfolio. This problem can be solved in one of two ways. The exposure of one security to each risk factor can be measured in isolation, with all others being fixed. This is akin to taking a partial derivative of the price of a security with respect to a given risk factor. Measures such as optionadjusted durations, spread durations and key rate durations are examples of partial derivatives. As an alternative to employing partial durations to measure risk associated with isolated movements of each risk factor, price sensitivity of securities and portfolios to the simultaneous change is several risk factors can be determined. Approaches of this type include value-at-risk measures.

Even after all of the relevant risks have been identified and the exposure of securities and portfolios to them has been measured, the ability to judge a market is still incomplete without knowledge of the joint probability distributions of systemic risk factors. Thus, the third step of risk management involves the estimation of the probabilistic distribution of risk factors. Many risk management models assume that instantaneous changes in risk factors follow a joint normal distribution.

The fourth and final step in the risk management process involves the actual computation of risk measures. This is done by estimating exposure of particular securities to a particular type of systemic risk or to market risk as a whole, and aggregating risk across the portfolio. This enables measurement of the risk of portfolios (assets) as well as the risk of their benchmarks (liabilities).

For portfolio managers, the task of understanding a wide range of financial instruments and efficiently managing multiple portfolios against numerous benchmarks in a risk controlled fashion demands significant resources and expertise. It is an established sound investment practice to minimize risk and maximize potential by maintaining a portfolio having diverse assets of different type and class. However, the computational challenges of risk measurement and management increases dramatically as the size of a portfolio and the diversity of its assets increase. For example, some financial instruments, such as mortgage-backed securities, may consist of a large amount of other financial instruments (i.e., loans) grouped together into one “pool.” Any modeling analyses applied to a pool or similar asset fund either requires using a method of mathematical estimation or the actual application of the analyses individually to each member in its constituency. Portfolios of fixed-income securities typically include many different varieties of these pools. Thus, the complexity and computational time associated with conducting modeling analyses is significantly increased when applied to such portfolios. Accordingly, there is a need in the art for a system that facilities the evaluation and management of risk across multiple portfolios of diverse fixed income securities and derivatives.

Typically, the analyses involve user-specified variables entered through a Graphical User Interface (GUI) for calculating modeling data in ways commonly used in the field of risk management. The results are used by the portfolio manager to make investment decisions. The calculations themselves may vary greatly in complexity, and are often unlikely to be finalized at the same point in time due to various factors effecting different classes of assets. Moreover, the type and/or magnitude of analyses differs for the different classes of assets making up the portfolio, as does the calculation time for a particular analysis. In addition, due to the substantial resources (i.e., relating to the computer memory, RAM and data processor) devoted to these types of calculations, the computer or GUI may appear to have “frozen” or experienced a critical error which requires rebooting of the computer. The processing time may be extended for systems in which the calculations are performed by a “main” computer or computer other than user's computer that communicates with the user's computer via local area network, world wide web or other data transfer network.

Given the problems described above, there exists a need for a system and method which provides the portfolio manager with the status or progress of the calculations and/or calculated results in a continuous, real-time manner so that the portfolio manager has the calculated results and status of any remaining calculations at their disposal at all times during the risk analysis.

### SUMMARY OF THE DISCLOSURE

The present disclosure is directed to a system for applying a variety of analyses to a portfolio of financial instruments which provides real-time notification of the status of those analyses during the time in which they are conducted.

The present disclosure is also directed to a method for monitoring the status of analyses performed on a portfolio of financial instruments. The method involves the steps of: providing a portfolio database having a plurality of portfolios; applying a selected analytical formula to selected financial instruments within a selected portfolio; and communicating the durational status of the application of a selected analytical formula with respect to each selected financial instrument. In one aspect of the present disclosure, the formulas may be applied by a analytical program or processor.

In the disclosed embodiments, the formulas are used for modeling the performance of financial instruments under user-specified conditions. It is contemplated that formulas or analyses of other types or for other purposes may be used with the system and method of the present disclosure. Nonetheless, the application of the selected analytical formulas to each selected financial instrument has a duration associated therewith, which typically differs depending upon the asset class of the selected financial instrument. Furthermore, each portfolio may contain a plurality of financial instruments of differing asset classes. Thus, the durational time for completion of the analytical formulas will likely differ for most of the financial instruments in the selected portfolio.

In addition, the aforementioned method may also include the steps of: receiving the selection of a portfolio of financial instruments; receiving the selection of at least one financial instrument within a selected portfolio; receiving the selection of an analytical formula to model the performance of selected financial instruments; receiving economic conditions to be inputted to the analytical formulas; and/or facilitating the application of a selected analytical formula to each financial instrument in a selected portfolio.

In another aspect of the aforementioned method, the step of communicating the durational status of the application of a selected analytical formula with respect to each selected financial instrument may include communicating one or more text messages, video, audio and/or animated graphics through a graphical user interface.

In addition, the aforementioned method in accordance with the present disclosure may include the step of receiving portfolio modification data for modifying one or more portfolios in the portfolio database and/or analytics modification data for modifying one or more analytical formulas or assumptions incorporated into the analytics program or processor. The modification data may be received via a local source such as a memory storage media, distributed computing network, data server, or local area network, or a remote source, such as a world wide web site or updating service making data transfers through wireless or phone line data transfer systems.

The present disclosure also provides a system for monitoring the status of analyses performed on a portfolio of financial instruments. The system includes a portfolio database of portfolios containing a plurality of financial instrunents, and means or devices for applying a selected analytical formula to selected financial instruments within a selected portfolio and communicating the durational status of the application of a selected analytical formula with respect to each selected financial instrument. The formulas are used to model the performance of financial instruments under user-specified conditions. However, it is within the purview of the present disclosure to incorporate other formulas in a system as disclosed herein. The application of a selected analytical formula to a selected financial instrument has a duration associated therewith which typically differs depending upon the asset class of the selected financial instrument. Furthermore, each portfolio has financial instruments which may be of varying asset classes. Thus, the durational time for completion of the analytical formulas will likely differ for most of the financial instruments.

In one embodiment of the present disclosure, the aforementioned system includes a memory storage device for the portfolios databases and analytical software. In another embodiment, the aforementioned system includes a data processing device, such as a Pentium based microprocessor, for applying the selected analytical formulas to the selected financial instruments to model the performance thereof. In yet another embodiment, the aforementioned system includes a visual output device, such as a computer monitor, for communicating the durational status of the application of the selected analytical formulas with respect to each selected financial instrument. Preferably, the visual output device is adapted and configured to display a graphical user interface.

The present disclosure also advantageously provides an alternative method for monitoring the status of analyses performed on a portfolio of financial instruments which involves the steps of: accessing a portfolio database of portfolios containing a plurality of financial instruments; applying one or more selected analytical formulas to selected financial instruments within a selected portfolio to model the performance thereof; and receiving the durational status of the application of one or more selected analytical formulas with respect to each selected financial instrument.

In addition, the aforementioned alternative method may include the steps of: selecting a portfolio of financial instruments; selecting at least one financial instrument within a selected portfolio of financial instruments; selecting an analytical formula to model the performance of selected financial instruments; and/or providing economic conditions to be modeled by the analytical formulas.

In one aspect of the aforementioned alternative method, the step of receiving the durational status of the application of a selected analytical formula with respect to each selected financial instrument may include receiving one or more text messages, video, audio and/or animated graphics through a graphical user interface.

In addition, the aforementioned alternative method in accordance with the present disclosure may include the step of providing portfolio modification data for modifying one or more portfolios in the portfolio database and/or analytics modification data for modifying one or more analytical formulas in the analytics program. The modification data may be provided via a local source such as a memory storage media, distributed computing network, data server, or local area network, or a remote source, such as a world wide web site or updating service making data transfers through wireless or phone line data transfer systems.

The present disclosure also advantageously provides an alternative system for monitoring the status of analyses performed on a portfolio of financial instruments including a portfolio database of portfolios containing a plurality of financial instruments of differing asset class, a device for applying one or more selected analytical formulas to selected financial instruments within a selected portfolio to model the performance thereof, and a device for receiving the durational status of the application of one or more selected analytical formulas with respect to each selected financial instrument.

In one embodiment of the aforementioned alternative system, the database and a program capable of applying analytical formulas are stored in a memory storage device. In another embodiment of this system, the device for applying one or more selected analytical formulas to selected financial instruments to model the performance thereof is a data processing device. In yet another embodiment, the device for receiving the durational status of the application of one or more selected analytical formulas with respect to each selected financial instrument is a visual output device, such as monitor, preferably adapted to display a graphical user interface.

The present disclosure also advantageously provides a machine readable media for monitoring the status of analyses performed on a portfolio of financial instruments. The media includes various data segments for storing financial instrument data relating to information about a plurality of financial instruments, storing analytics data relating to a plurality of analytical formulas for modeling performance of financial instruments, and storing modeling data relating to the user-specified analytical formulas to perform and selected financial instruments to model. The media also includes various code segments for receiving the modeling data, retrieving the financial instrument data, retrieving the analytics data, performing the user-specified analytical formulas based on the modeling data, financial instrument data, and analytics data to model performance of the selected financial instruments, and communicating the durational status of the user-specified analytical formulas until performance of all the user-specified analytical formulas is finalized.

These and other unique features of the system and method disclosed herein will become more readily apparent from the following description of the drawings.

### BRIEF DESCRIPTION OF THE FIGURES

So that those having ordinary skill in the art to which the subject invention pertains will more readily understand how to make and use the system of the subject invention, embodiments thereof will be described in detail hereinbelow with reference to the figures, wherein:

FIG. 1 is a flow diagram illustrating the method steps associated with a status monitoring system constructed in accordance with the present disclosure;

FIG. 2 is a schematic diagram depicting the core functional components of a computer-based system for implementing the method steps shown in FIG. 1;

FIG. 3is an example of a main graphical user interface of a analytics system in accordance with the present disclosure;

FIG. 4 is an example of a portfolio reporting screen of the analytics system in accordance with the present disclosure having a portfolio of fixed income securities loaded therein, prior to performing an analyses of the financial instruments in the portfolio;

FIG. 5 is an example of a portfolio reporting screen for the portfolio of assets shown in FIG. 4 during the performance of an analyses of the financial instruments in the portfolio, wherein status messages are presented with respect to each asset in the portfolio;

FIG. 6 is an example of the portfolio reporting screen of FIG. 4 at the completion of an analyses of the financial instrument in the portfolio; and

FIG. 7 is an example of a main analytics reporting screen in accordance with the present disclosure which may be used by the portfolio manager to view the results of the analyses for each financial instrument in the portfolio.

### DETAILED DESCRIPTION OF THE PREFERRED EMBODIMENTS

The subject disclosure is directed to a new and useful risk management tool in the form of a personal computer system or server-based system configured to provide intraday real-time relative value analysis and reporting across multiple portfolios of diverse financial instruments, such as fixed income securities and derivatives. In a server-based system the analysis may be completed remotely and displayed on the user's computer screen. It is understood that its use in conjunction with fixed income securities is exemplary of the type of product and circumstance for which the present disclosure is well suited. Those skilled in the art will readily appreciate that a system in accordance with the present disclosure may be used in conjunction with other products as well.

Those skilled in the art will also readily appreciate that a system in accordance with the present disclosure includes the various computer and network related software and hardware used in a distributed computing network, that is, programs, operating systems, memory storage devices, input/output devices, data processors, servers with links to data communication systems, wireless or otherwise, such as those which take the form of a local or wide area network, and a plurality of data transceiving terminals within the network, such as personal computers. Those skilled in the art will further appreciate that, so long as its users are provided local and remote access to a system in accordance with the present disclosure, the precise type of network and associated hardware are not vital to its full implementation.

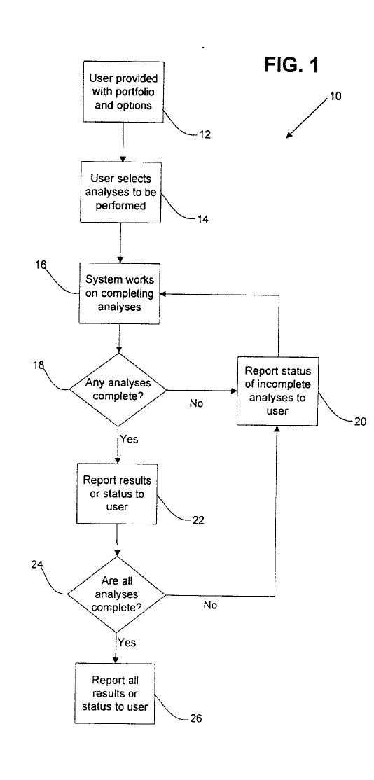

Referring now to FIG. 1, a flow diagram illustrating the basic functions of a system 10 constructed in accordance with the subject disclosure and configured to perform a variety of analyses for managing risk associated with a portfolio of financial instruments such as fixed income securities. In process step 12, a user (hereinafter also referred to as “portfolio manager”) is provided with a broad range of data relating to a portfolio under management, including the option to perform various types of analyses which are run via the local, remote, or server memory units and processing devices.

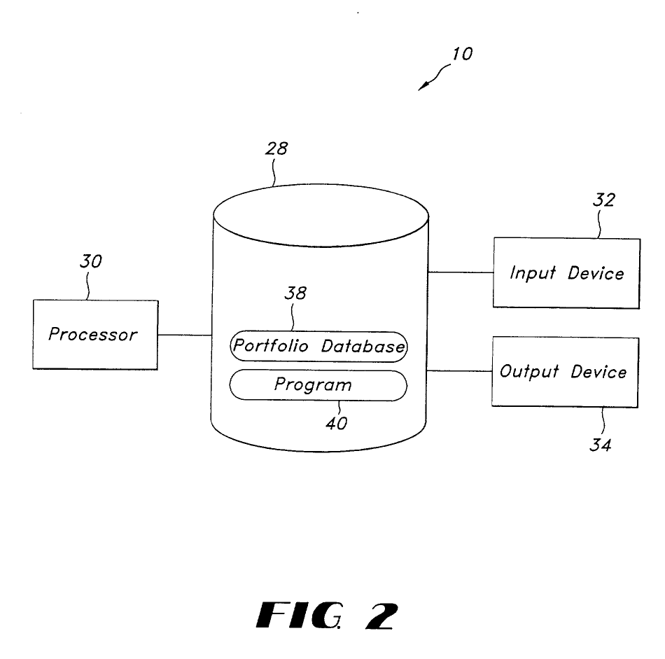

There is illustrated in FIG. 2 a schematic representation of an exemplary computerized system 10 constructed in accordance with the present disclosure for performing the process steps shown in FIG. 1. Thus, system 10 is adapted and configured to analyze entire portfolios of financial instruments and provide status notifications related to the duration of the analyses for each individual financial instrument, among other things.

System 10 includes a data storage device or memory 28 and a processor 30 which is operatively associated with the memory 28 for managing the flow of data throughput. A data input device 32 is operatively associated with the memory 28 and processor 30 for receiving data and instructions from a portfolio manager or other source of financial or investment information, and a data output device 34 is operatively associated with the memory 28 and processor 30 for reporting information to an interested party.

The memory 28 contains a plurality of cooperative relational databases. These databases include a portfolio database 38 for storing a plurality of investment portfolios containing information relating to the specific assets or financial instruments and corresponding asset classes within the portfolios. Each portfolio may include a plurality of financial instruments including, among other things, fixed income securities such as Treasury notes, Corporate and Agency bond issues, mortgage backed securities, money market instruments, equities, currencies and derivative instruments.

Memory 28 also stores a program 40 containing an instruction set written in a conventional computing language such as C++ or Java, for coordinating the interactive relationship between the memory 28, the processor 30, and the input and output devices 32, 34. Program 40 may also be capable of applying a plurality of analyses for different assets and/or asset classes which may relate to, among other things, measures useful for modeling performance of a financial instrument under various economic conditions.

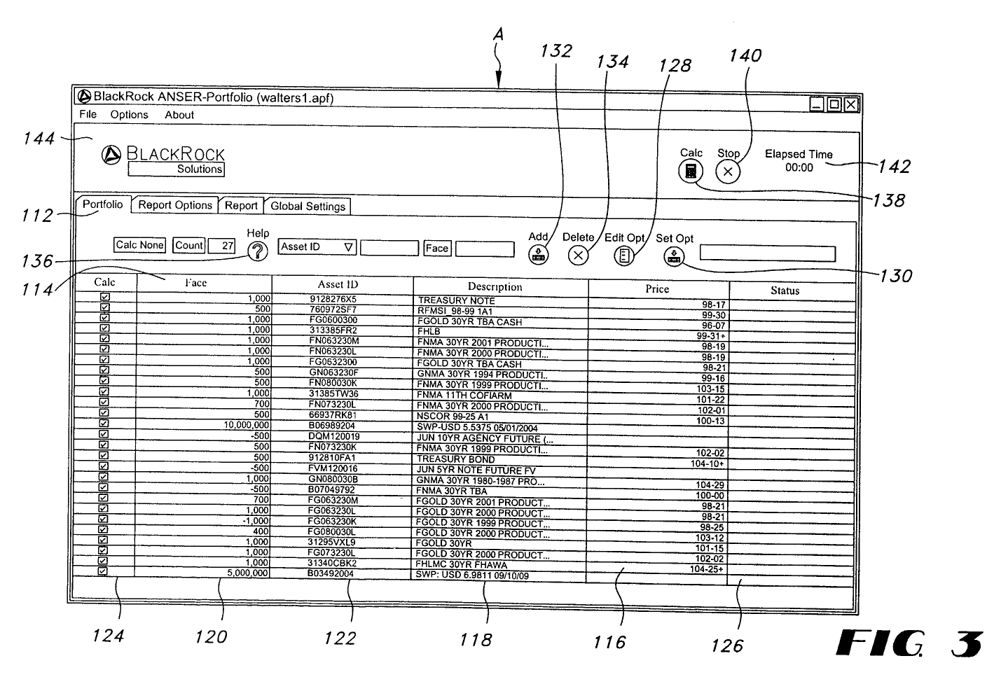

FIG. 3 illustrates an exemplary graphical user interface (or “screen”) “A” for use in an embodiment of the present disclosure which substantially corresponds with the process step 12. Preferably, system 110 and its screen interfaces incorporate user-friendly features designed to fit seamlessly with the most common operating system interfaces. Thus, the screens are in a framed form having embedded links to other screens, borders, multiple folders, toolbars with pull-down menus and various other features which are accessible by depressing (i.e., “clicking”) on animated graphical representations of buttons, among other things. Features of system 110 may be accessed via a connected mouse, keyboard, voice command or other commonly used tool for indicating preference in a computerized graphical interface.

Screen A provides the portfolio manager with a portfolio folder 112 having a comprehensive portfolio table 114 of assets, such as fixed-income securities, and associated data fields. In this embodiment, such fields include price fields 116, description fields 118, face value fields 120, asset identification code fields 122, calculation selection fields 124 and calculation status fields 126. As illustrated by the checked boxes in calculation selection fields 124, the default setting in system 110 is configured to include all assets in all calculations. Screen A also provides the portfolio manager with the ability to add, delete, or alter features related to securities in table 114. Options related to the securities in table 114 may be edited and set by buttons 128 and 130, respectively. Securities may be added by button 132 or deleted by button 134. Help button 136 provides assistance for using system 110. A calculation start button 138, calculation stop button 140 and time counter 142 are incorporated in the border 144 around portfolio folder 112. Border 144 may also contain a trademark or company symbol or name, such as “BlackRock Solutions” as shown.

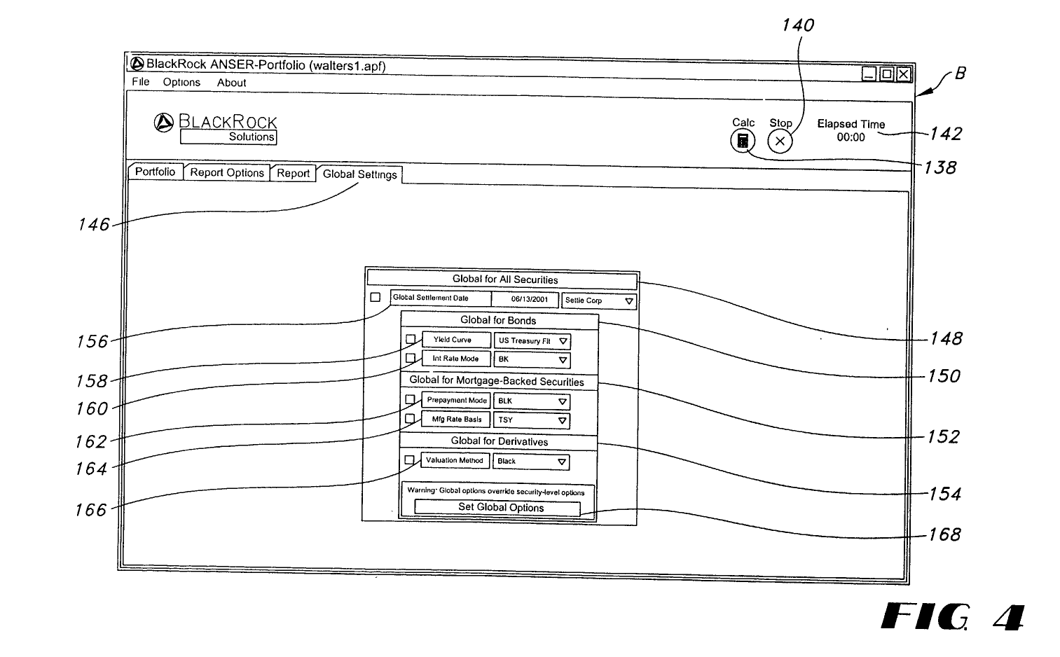

Referring now to FIG. 4, a screen “B” is illustrated as an exemplary interface which provides the features corresponding with process step 14. Screen B depicts the global settings folder 146 which provides the portfolio manager with the ability to adjust settings relating to all securities in table 114 of a specific type or asset class. In this embodiment, there are fields which can be applied to all securities 148 or solely for bonds 150, mortgage-backed securities 152 or derivatives 154. The adjustable settings may include a wide range of variables relating to conditions to be simulated by the desired models. Typical variables may include, but are not limited to, real-time yield curves such as Treasury and LIBOR curves, prepayment models and curve shocks. The portfolio manager may also specify the data to be used in the analyses, by locking the economy, enabling real-time data or by specifying a user economy, among other things. In this embodiment, a settlement date field 156 may be globally adjusted for all securities. For bonds only, a yield curve field 158 and interest rate model field 160 may be globally adjusted. For mortgage-backed securities only, a prepayment model field 162 and mortgage rate basis field 164 may be globally adjusted. Lastly, for derivatives only, a valuation method field 166 may be adjusted. Selected variables are shown in the corresponding fields on screen B. Once the desired combination has been chosen, the set global options button 168 is depressed to apply the selected variables to the securities in table 114 which overrides any previous settings.

In performing the analytical computations on a portfolio of fixed income securities, the computational time for performing the calculation on each type of asset or asset class within the portfolio can vary substantially from one asset to another. For some securities, such as a U.S. Treasury Note, the computational time for performing a particular calculation may take only a few seconds, whereas the computational time for the same analysis with respect to a mortgage backed security, such as a FNMA 30YR TBA may be considerably longer as the calculation is relatively more complex.

As shown by process steps 16 through 24 in FIG. 1, system 10 provides a loop for performing continuous status checks on the specified analyses until the analyses have been completed. Once computations have begun in process step 16, system 10 checks if any analyses have been completed as shown by process step 18. If there are no completed analyses, that condition is reported to the portfolio manager in process step 20 while the derivations continue. If one or more analyses have been completed, its results or a message indicating that certain analyses have been completed along with the incomplete status of the remaining analyses will be reported to the portfolio manager as illustrated by process steps 20 and 22. The remaining computations continue subject to the same constant updating process loop until all analyses are complete. As shown by process steps 24 and 26, once all analyses are complete, the process loop culminates by reporting the status to the portfolio manager. Any errors encountered during the analyses are also reported to the portfolio manager.

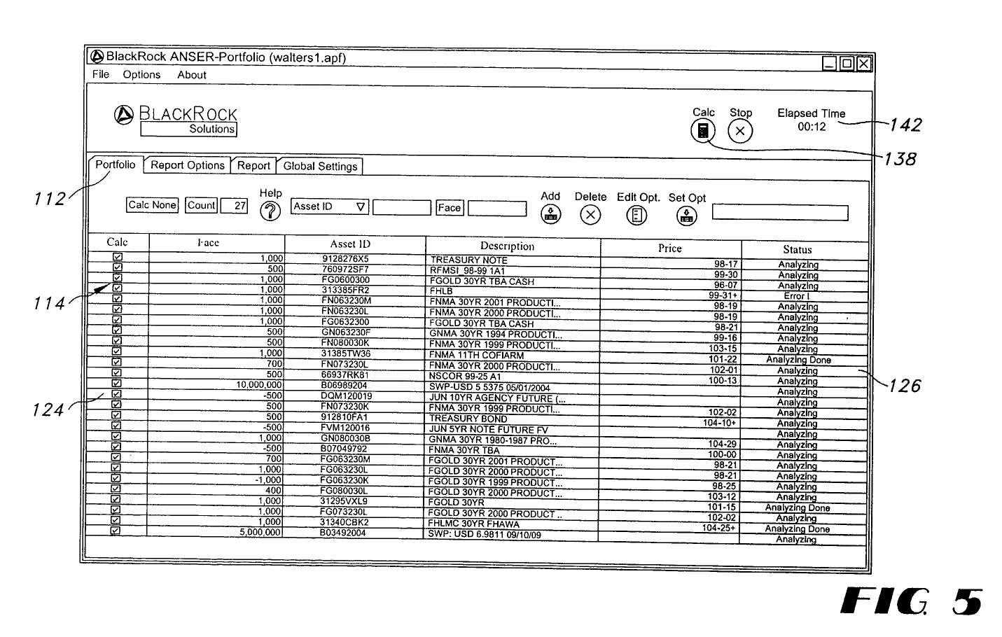

FIG. 5 depicts an exemplary screen “A” after calculation button 138 has been actuated to begin the computations. Time counter 142 shows that 12 seconds has elapsed since the analyses began and status fields 126 are providing the portfolio manager with text status messages for each security in table 114. As illustrated, some of the analyses have been completed but most have not. Preferably, the messages are color-coded for each status update. For example, “Analyzing” may be red while “Analyzing Done” may be green. Exemplary status messages may also include “CALCULATING” or “ANALYSIS COMPLETE”, etc. It is understood that the messages may differ, change color, flash or in some other way indicate the relative state of the analysis. Also, programmable animated items may be utilized to indicate the progression of time until each or all of the analyses are complete, such as an hourglass or linear temporal meter having graduations for indicating the passage of time. Alternatively, a timer may be provided indicating an approximation of the amount of time remaining to complete the analysis.

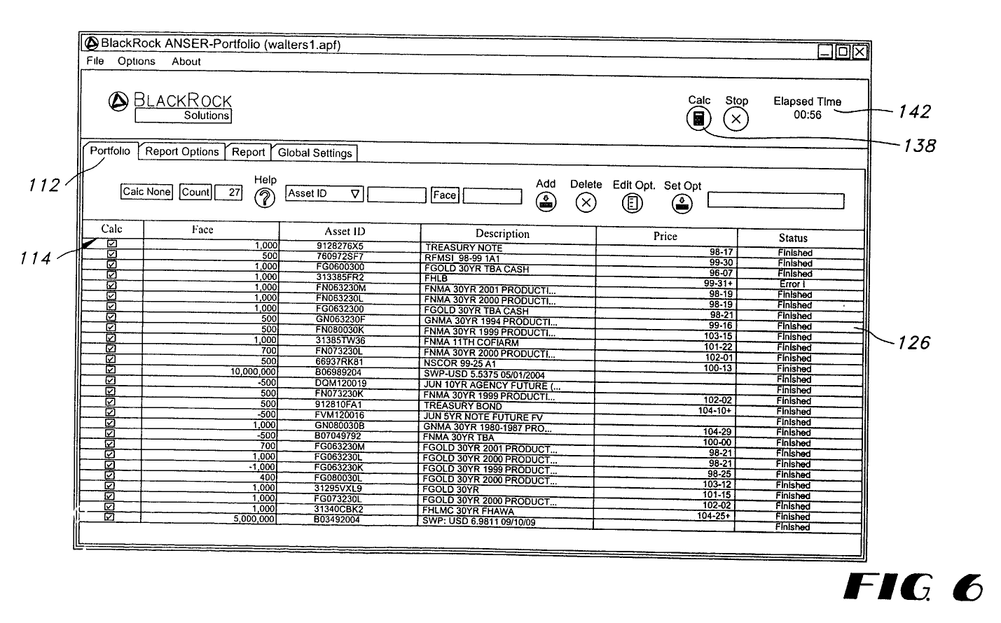

FIG. 6 depicts an exemplary screen “A” after 56 seconds have elapsed as evidenced by time counter 142 and the specified analyses have all been completed. All the status fields 126 for securities in table 114 contain the text “Finished” except for one which has an “Error” text message in its respective status field 126.

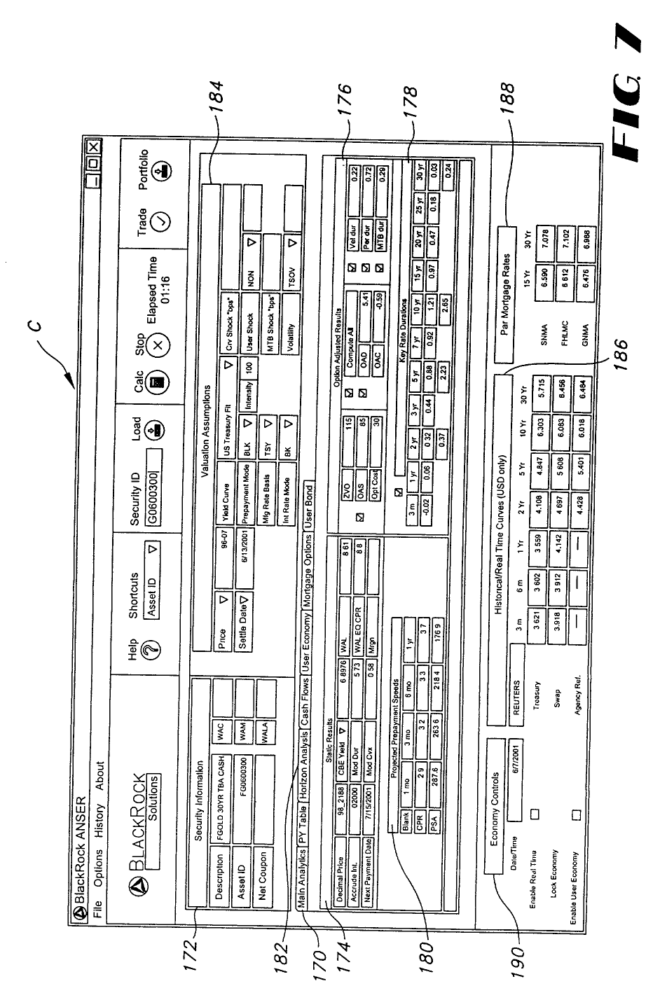

The various analyses provide techniques and tools for conducting risk management modeling. The results of the analyses may be presented to the portfolio manager in a variety of ways. FIG. 7 illustrates an exemplary graphical interface screen “C” for viewing the results of the analyses and various factors generated by the analyses useful to the portfolio manager for making risk management decisions for each security. A main analytics folder 170 illustrates various techniques and tools made available to the portfolio manager by system 10 for each security. The particular security under examination is listed in the information table 172. In this embodiment, the analyses are used to generate data including, but not limited to, static measures 174 such as price/yield tables, spread pricing, modified duration, modified convexity; option adjusted measures 176 such as option-adjusted spread (OAS), option adjusted duration (OAD), option adjusted convexity (OAC); key rate durations (KRD) 178 and projected prepayment speeds 180; and horizon analysis 182 such as expected rate of return (EROR). The valuation assumptions table 184 includes the original variables set globally in screen B. Main anaytics folder 170 also provides comparison data such as historical/real-time curves 186, par mortgage rates 188 and economy control options 190.

The system and method of the subject disclosure provides real-time notification of the status of a particular calculation with respect to each fixed income security in a particular portfolio under analyses. Although the preferred and exemplary embodiments of the present disclosure have been described with a full set of features, it is to be understood that the disclosed system and method may be practiced successfully without the incorporation of each of those features. It is to be further understood that modifications and variations may be utilized without departure from the spirit and scope of this inventive system and method, as those skilled in the art will readily understand. Such modifications and variations are considered to be within the purview and scope of the appended claims and their equivalents.

What is claimed is:

1. A method for monitoring the status of analyses performed on a portfolio of financial instruments, comprising the steps of:
a) providing a portfolio database including a plurality of portfolios, wherein each portfolio contains a plurality of financial instruments of differing asset class;
b) applying a selected analytical formula to selected financial instruments within a selected portfolio to model the performance thereof, wherein the application of a selected analytical formula to a selected financial instrument has a duration associated therewith depending upon the asset class of the selected financial instrument; and
c) communicating the durational status of the application of a selected analytical formula with respect to each selected financial instrument.

2. A method according to claim 1, further comprising the step of receiving the selection of a portfolio of financial instruments.

3. A method according to claim 1, further comprising the step of receiving the selection of at least one financial instrument within a selected portfolio.

4. A method according to claim 1, further comprising the step of receiving the selection of an analytical formula to model the performance of selected financial instruments.

5. A method according to claim 1, further comprising the step of receiving economic conditions to be inputted in the analytical formulas.

6. A method according to claim 1, further comprising the step of facilitating the application of a selected analytical formula to each financial instrument in a selected portfolio.

7. A method according to claim 1, wherein the step of communicating the durational status of the application of a selected analytical formula with respect to each selected financial instrument includes communicating one or more text messages through a graphical user interface.

8. A method according to claim 7, wherein the text messages are communicated in one or more colors.

9. A method according to claim 1, wherein the step of communicating the durational status of the application of a selected analytical formula with respect to each selected financial instrument includes communicating an audio message through a graphical user interface.

10. A method according to claim 1, wherein the step of communicating the durational status of the application of a selected analytical formula with respect to each selected financial instrument includes communicating a sequence of animated graphics through a graphical user interface.

11. A method according to claim 1, further comprising the step of receiving portfolio modification data for modifying one or more portfolios in the portfolio database.

12. A method according to claim 1, further comprising the step of receiving analytics modification data for modifying one or more analytical formulas.

13. A system for monitoring the status of analyses performed on a portfolio of financial instruments, comprising:
a) a portfolio database including a plurality of portfolios, wherein each portfolio contains a plurality of financial instruments of differing asset class;
b) means for applying a selected analytical formula to selected financial instruments within a selected portfolio to model the performance thereof, wherein the application of a selected analytical formula to a selected financial instrument has a duration associated therewith depending upon the asset class of the selected financial instrument; and
c) means for communicating the durational status of the application of a selected analytical formula with respect to each selected financial instrument.

14. A system as recited in claim 13, wherein the database is stored in a memory storage device.

15. A system as recited in claim 13, wherein the means for applying a selected analytical formula to selected financial instruments within a portfolio to model the performance thereof comprises a data processing device.

16. A system as recited in claim 13, wherein the means for communicating the durational status of the application of a selected analytical formula with respect to each selected financial instrument is a visual output device.

17. A system as recited in claim 16, wherein the visual output device is adapted and configured to display a graphical user interface.

18. A system as recited in claim 13, wherein the financial instrument s comprise fixed-income securities.

19. A met hod for monitoring the status of analyses performed on a portfolio of financial instruments, comprising the steps of.
a) accessing a portfolio database including a plurality of portfolios, wherein each portfolio contains a plurality of financial instruments of differing asset class;
b) applying one or more selected analytical formulas to selected financial instruments within a selected portfolio to model the performance thereof, wherein the application of a selected one or more analytical formulas to each selected financial instrument has a duration associated therewith depending upon the asset class of the selected financial instrument; and
c) receiving the durational status of the application of one or more selected analytical formulas with respect to each selected financial instrument.

20. A method according to claim 19, further comprising the step of selecting a portfolio of financial instruments.

21. A method according to claim 19, further comprising the step of selecting at least one financial instrument within a selected portfolio.

22. A method according to claim 19, further comprising the step of selecting an analytical formula to model the performance of selected financial instruments.

23. A method according to claim 19, further comprising the step of inputting economic conditions in the analytical formulas.

24. A method according to claim 19, wherein the step of receiving the durational status of the application of one or more selected analytical formulas with respect to each selected financial instrument includes receiving one or more text messages through a graphical user interface.

25. A method according to claim 19, further comprising the step of providing portfolio modification data for modifying one or more portfolios in the portfolio database.

26. A method according to claim 19, further comprising the step of providing analytics modification data for modifying one or more analytical formulas.

27. A system for monitoring the status of analyses performed on a portfolio of financial instruments, comprising:
a) a portfolio database including a plurality of portfolios, wherein each portfolio contains a plurality of financial instruments of differing asset class;
b) means for applying one or more selected analytical formulas to selected financial instruments within a selected portfolio to model the performance thereof, wherein the application of a selected one or more analytical formulas to each selected financial instrument has a duration associated therewith depending upon the asset class of the selected financial instrument; and
c) means for receiving the durational status of the application of one or more selected analytical formulas with respect to each selected financial instrument.

28. A system as recited in claim 27, wherein the database is stored in a memory storage device.

29. A system as recited in claim 27, wherein the means for applying one or more selected analytical formulas to selected financial instruments within a portfolio to model the performance thereof comprises a data processing device.

30. A system as recited in claim 27, wherein the means for receiving the durational status of the application of one or more selected analytical formulas with respect to each selected financial instrument is a visual output device.

31. A system as recited in claim 27, wherein the visual output device is adapted and configured to display a graphical user interface.

32. A machine readable media for monitoring the status of analyses performed on a portfolio of financial instruments, comprising:
a) a data segment for,
i) storing financial instrument data relating to a plurality of financial instruments in a portfolio;
ii) storing analytics data relating to a plurality of analytical formulas for modeling performance of financial instruments;
iii) storing modeling data relating to the user-specified analytical formulas to perform and selected financial instruments to model;
b) a code segment for,
i) receiving the modeling data;
ii) retrieving the financial instrument data;
iii) retrieving the analytics data;
iv) performing the user-specified analytical formulas based on the modeling data, financial instrument data, and analytics data to model performance of the selected financial instruments;
v) communicating the durational status of the user-specified analytical formulas until the performance of the user-specified analytical formulas is finalized.
